(19) United States
(12) Patent Application Publication
(10) Pub. No.: US 2021/0152068 A1
(43) Pub. Date: May 20, 2021

(54) STATOR ARRANGEMENT FOR AN ELECTROMAGNETIC LINEAR DRIVE

(71) Applicant: thyssenkrupp Elevator Innovation and Operation GmbH, Essen (DE)

(72) Inventors: Jürgen FRANTZHELD, München (DE); Philippe GAINCHE, Großbettlingen (DE)

(73) Assignee: thyssenkrupp Elevator Innovation and Operations GmbH, Essen (DE)

(21) Appl. No.: 16/622,993

(22) PCT Filed: Jun. 13, 2018
(86) PCT No.: PCT/EP2018/065636

§ 371 Date: Dec. 16, 2019

(30) Foreign Application Priority Data
Jun. 16, 2017 (DE) 10 2017 113 289.9

(51) Int. Cl. H02K 41/03; H02K 11/215; H02K 29/08; H02K 3/28

(52) U.S. Cl. CPC H02K 41/031; H02K 3/28; H02K 29/08; H02K 11/215

(57) ABSTRACT

A stator arrangement for an electromagnetic linear drive may include a plurality of stator coils that are arranged along a longitudinal direction of a stator. The stator arrangement may also include a plurality of converters that are configured, in each case, to supply at least one first stator coil and a second stator coil of the stator coils with electrical energy. Between the first stator coil and the second stator coil, at least one third stator coil of the stator coils is arranged, which is supplied by a different converter from the first stator coil and the second stator coil.

The present invention relates to a stator arrangement for an electromagnetic linear drive, and is thus included in the field of linear drives, specifically for elevator installations, escalators and/or moving walkways. The invention further relates to a corresponding elevator installation.

### PRIOR ART

Transport facilities, specifically elevator installations, escalators and moving walkways with no cable or chain drive system, are sometimes equipped with electromagnetic linear drives, which permit elevator cars to be moved individually and in a mutually independent manner over both vertical and horizontal route segments, and moving walkway pallets or escalator treads to be conveyed along the route individually, rather than in an interconnected chain. Electromagnetic linear drives comprise here at least one stationary linear stator, which is arranged in a plurality of parallel or sequential stator segments, having separate stator coils or stator windings, along the route, for example in an elevator shaft, and at least one linear rotor which, within the meaning of the present invention, corresponds to a car or a pallet.

The rotor will therefore be considered here, rather than the car or the pallet. The rotor engages with the stator arrangement or with the stator in a contactless, but closest possible magnetic coupling, in order to achieve a strongest possible action of force of the moving field generated by the stator, and to generate a strongest possible concentrated magnetic flux in the stator core and in the rotor. Permanent magnet rotors are typically employed for this purpose, such that no transmission of electrical energy to the rotor is required, and static magnetic retention forces can be achieved. It is thus a so called synchronous drive.

In many cases, for the supply of the stator coils with electrical energy and/or for the controlled conveyance of the rotor, various electrical components are required, which it is necessary to arrange in and/or on the stator or the stator arrangement, and to connect to the stator coils. Accordingly, under certain circumstances, it is necessary for multiple components to be fitted in a restricted space. Moreover, a malfunction and/or failure of electrical components can result in an impairment of the mobility of the rotor, or even in a failure of control of the position of the rotor. Specifically, in a worst case, a failure of electrical components and/or of the stator coils may entail a risk of the falling of the rotor relative to the stator arrangement.

It is therefore desirable to provide a stator arrangement which permits a highly reliable operation and which, in the event of a malfunction and/or failure of electrical components, permits a safe control of the rotor.

### DISCLOSURE OF THE INVENTION

According to the invention, a stator arrangement with the features of the independent patent claim is proposed. Advantageous configurations are the subject matter of the sub-claims, and of the following description.

A first aspect of the invention relates to a stator arrangement for an electromagnetic linear drive, wherein the stator arrangement comprises a plurality of stator coils, which are arranged along a longitudinal direction of the stator. The stator arrangement further comprises a plurality of converters, which are configured, in each case, to supply at least one first stator coil and one second stator coil of the plurality of stator coils with electrical energy. Here between the first stator coil and the second stator coil, at least one third stator coil of the plurality of stator coils is arranged, which is supplied by a different converter than the first stator coil and the second stator coil.

A further aspect of the invention relates to an elevator installation having a stator arrangement according to the invention.

According to the invention, at least two stator coils are supplied with electrical energy by a converter. The invention provides the advantage, in that the number of converters to be provided can be reduced, and the number of converters does not necessarily have to correspond to the number of stator coils in the stator arrangement. In this manner, the supply of electrical energy to the stator coils can be achieved in an exceptionally space-saving and exceptionally cost-effective manner.

Given that, according to the invention, the same converter supplies two stator coils at a further distance rather than two directly adjoining stator coils, wherein between said two stator coils at a further distance at least one other stator coil is situated, which is not supplied by the same converter, the availability of the stator arrangement or the conveyance of the rotor is increased. In this manner, it is specifically achieved that, in the event of a defect and/or a failure and/or a malfunction of one converter, there is no failure of function in a plurality of directly adjoining stator coils. Instead, it is thus achieved that any stator coil which is impaired in its function, for example on the grounds that the stator coil is no longer supplied with electric power, is surrounded in each case by stator coils, the function of which is not impaired, provided that there is no failure of further converters, which supply the adjoining stator coils. Specifically, the stator arrangement can be configured such that, in the event of a failure of the function in one supply segment, the operation of the stator arrangement can be maintained, at least for such an amount of time, which is required for a reliable positioning of the rotor and/or for a repair of the stator arrangement or for a replacement of the defective converter.

The invention ensures that, the rotor can still be moved by the stator in the event of a failure of a converter, and that said rotor can also cross over the stator coils which, on the grounds of the failed converter, are no longer properly supplied with electric power. Particularly, the stator arrangement can be configured such that the respectively adjoining stator coils, which adjoin a stator coil which is no longer properly supplied with electrical energy, compensate the function of the failed stator coil at least partially and to a sufficient extent, such that the rotor can continue to be moved by the stator arrangement. Alternatively, the stator arrangement can be configured such that, in the event of a failure of one converter and a corresponding failure of two or more stator coils which are supplied with electrical energy during a fault-free operation of the supply segment concerned, the position of the rotor can be controlled, such that at least a potentially impending risk of the falling of the rotor relative to the stator can be reliably prevented.

The stator arrangement preferably comprises a plurality of connection elements which are configured, in each case, to supply at least a first converter and a second converter of the plurality of converters with electrical energy. Hereby the first converter and the second converter are configured, in each case, to supply at least two stator coils with electrical energy. Moreover, in this embodiment all the stator coils which are supplied with electrical energy via the same connection element of the plurality of connection elements constitute a first group of stator coils, wherein at least one further stator coil is arranged between any two stator coils from the first group of stator coils, which further stator coil is supplied via another connection element of the plurality of connection elements.

This provides the advantage in the event of the failure of one connection element that no two adjoining stator coils are affected by the failure, but that one further stator coil, which is not affected by the failure, is arranged between two stator coils which are affected by the failure of the connection element. Accordingly, even in the event of a failure of a connection element, the operation of the stator arrangement can preferably be maintained and/or a failure of the propulsive force can be prevented.

The stator arrangement preferably comprises a plurality of supply segments, wherein each supply segment comprises at least two supply components from the quantity of the plurality of converters and the plurality of connection elements, and wherein all the stator coils which are supplied with electrical energy via the same supply segment constitute a second group of stator coils. At least one further stator coil is thereby arranged between any two stator coils of the second group of stator coils, wherein the at least one further stator coil is supplied via another supply segment of the plurality of supply segments. In other words, a supply component can comprise a converter and/or a connection element, or can describe a converter and/or a connection element. In other words, specifically, a supply segment can preferably comprise a plurality of converters. This provides the advantage in that, in the event of the failure of a supply segment, non-directly-adjoining stator coils are affected by the failure, whereas at least one further stator coil is arranged between the stator coils which are affected by the failure, which is supplied by another supply segment, and is thus not affected by the failure of the supply segment. Accordingly, even in the event of a failure of one supply segment, the operation of the stator arrangement can be maintained and/or a falling of the rotor relative to the stator arrangement can be prevented.

Preferably, the supply segments are individually mountable to the stator arrangement and/or individually removable from the stator arrangement. It is specifically preferred if each of the supply segments is configured as a compact and/or closed unit. This provides the advantage, in that the constituent supply components of a supply segment, i.e. components which are specifically required for the supply of the stator arrangement or the stator coils with electrical energy, such as, for example, converters, are provided in a compact form, and can be arranged on or in the stator arrangement. This can reduce, for example, the complexity of manufacture and/or assembly of the stator arrangement. For example, supply segments of this type can be already finished in-factory and thus, during the construction of an elevator installation, a moving walkway and/or an escalator, can be installed in such a ready-assembled condition in a stator arrangement or fitted to a carrier element.

This provides the further advantage that the respective supply segment can be removed as a whole and/or be replaced, in the event of a defect of a supply segment and/or in the event of a defect of individual supply components configured in the supply segment. In this manner, for example, it can be achieved that the requisite time for a repair can be reduced, and a duration of any failure of the stator arrangement or of the elevator installation can be limited accordingly. As the supply segment can preferably be individually removed from the carrier element, it can specifically be achieved that the necessary complexity associated with the replacement of a supply segment is reduced, as it is not necessary for any other supply segments which may possibly not be damaged, to be removed and/or unwired, in order to permit the removal of the desired supply segment.

Specifically, a plurality of supply segments can preferably be arranged next to one another or one above another along the longitudinal direction of the stator arrangement. The arrangement can be configured with regular or irregular spacing. Moreover, supply segments can be configured in a directly mutually contiguous arrangement along the longitudinal direction of the stator arrangement, or can be spaced from one another.

Preferably, each of the supply segments comprises at least one converter of the plurality of converters. A converter can be configured, for example, to adapt an electric voltage to meet the requirements of the stator coils. For example, a converter can be configured to convert an alternating voltage into a direct voltage, or vice versa, or to modify a frequency of an alternating voltage. Specifically, the converter preferably permits the execution by the supply segment of the function for the supply of electrical energy to the stator coils which are to be supplied by said supply segment. This provides the advantage, in that the converter can be configured in a compact arrangement in, or together with the supply segment.

Each of the supply segments preferably comprises at least two converters. Specifically, a converter can be configured to supply a plurality of non-adjoining stator coils with electrical energy. If the supply segment comprises a plurality of converters, the number of non-adjacent stator coils which are supplied with electrical energy by one supply segment is significantly increased. If, for example, a supply segment comprises two converters, and each of the two converters supplies two non-adjoining stator coils with electrical energy, four non-adjoining stator coils can be supplied with electrical energy by one supply segment. If a malfunction occurs in a supply segment of this type, on the grounds of which one of the converters is impaired in its function, a resulting consequence of this would then be the failure of the non-adjoining stator coils which are supplied with electrical energy by said converter, i.e. two non-adjoining coils, according to this example. If a malfunction occurs in a supply segment of this type, on the grounds of which the entire supply segment is impaired in its function, i.e., specifically, both converters of the supply segment are impaired in their function, a resulting consequence of this would then be the failure of all the stator coils which are supplied with electrical energy by said supply segment. However, as all the stator coils affected by the failure are arranged with a mutual spacing from one another and, specifically, other coils are arranged between the coils which are affected by the failure, it is possible, in this manner, for the function of the stator arrangement to be at least partially maintained.

It is specifically preferred if the at least one converter of the respective supply segment, in a direction which is perpendicular to the longitudinal direction of the stator arrangement, is arranged at least partially away from a midpoint of the supply segment. In other words, the at least one converter is not centrally arranged in or on the supply segment, in the direction which is perpendicular to the longitudinal direction, but is laterally arranged on the supply segment. This can provide the advantage, for example, in that a cooling of the converter, insofar as necessary, is facilitated, as the converter, on the grounds of the lateral arrangement, can be more easily accessible and/or a more effective evacuation of heat can be permitted, on the grounds that, optionally, fewer other components are arranged around the converter. If a supply segment comprises a plurality of converters, specifically two converters, these are preferably configured or arranged on opposing sides of the supply segment. Specifically, according to further preferred forms of embodiment, the at least two converters can be symmetrically arranged on or in the supply segment.

In this embodiment the stator coils are preferably configured as magnetic coils and/or as electromagnets. Specifically, the stator coils are configured to generate a magnetic field in response to the excitation thereof by a current flux. The stator coils are thereby preferably actuated such that the stator coils permit a drive of the rotor along the longitudinal direction of the stator. Specifically, the stator coils are preferably arranged such the stator coils define or constitute a track for the at least one rotor, along which the at least one rotor can be moved, relative to the stator.

Preferably, at least a proportion of the supply segments, and preferably each supply segment, comprises at least one sensor element, which is configured to deliver a sensor signal in response to a presence of a rotor at a given position on the supply segment, wherein said rotor is moveable relative to the stator arrangement. For example, the sensor element can be configured as a magnetic field sensor such as, for example, a Hall effect sensor. This provides the advantage, in that the sensor elements which are required to determine a presence and/or an absence and/or a position of the rotor relative to the stator arrangement do not need to be provided or arranged separately, but can be provided in combination with other components, specifically as an integral proportion of the supply segments, together with the respective supply segment. Moreover, the combination of supply segments can comprise at least one further sensor element, which is configured to detect a presence of a fault and/or a malfunction in, and/or damage to the stator arrangement and/or to a supply segment.

The stator arrangement is preferably oriented at least partially in a vertical direction and/or at least partially in a horizontal direction, wherein the longitudinal direction is parallel to the orientation of the stator arrangement. In other words, the longitudinal direction consistently refers to the orientation direction of the stator arrangement. The stator arrangement does not necessarily need to run vertically, but can also, for example, at least partially run horizontally. It is specifically preferred that the plurality of stator coils are arranged along the stator arrangement, such that they constitute a track for a rotor which is moveable relative to the stator arrangement.

The stator arrangement preferably comprises a plurality of supply terminals, each of which is configured to supply at least one first connection element and one second connection element of the plurality of connection elements with electrical energy, wherein all the stator coils which are supplied with electrical energy via the same supply terminal of the plurality of supply terminals constitute a second group of stator coils. At least one further stator coil is arranged between any two stator coils in the second group of stator coils, wherein the at least one further stator coil is supplied via another supply terminal of the plurality of supply terminals (21). This provides the advantage in that, in the event of the failure of a supply terminal, non-directly-adjoining stator coils are affected by the failure whereas, in each case, at least one stator coil, which is not affected by the failure of the supply terminal, is arranged between the stator coils, which are affected by the failure of the supply terminal. Accordingly, even in the event of the failure of a supply terminal, the operation of the stator arrangement can preferably be maintained and/or a falling of the rotor relative to the stator arrangement can be prevented. Specifically, each of the supply terminals preferably comprises at least two supply lines. It is specifically preferred that the at least two supply lines constitute a redundant arrangement for the supply of electrical energy to the supply terminals. This provides the advantage in that, in the event of a failure of one of the supply lines, the supply of electrical energy or electric power can be at least partially maintained by means of the respective other supply line.

In a specifically preferred manner, the invention can be employed in a multicar elevator installation, in which a plurality of rotors, or cars, in a shaft are arranged to move over one another and/or next to one another in a mutually independent manner. For example, a plurality of stators can be arranged here next to one another wherein, preferably, each stator is provided with supply segments.

Further advantages and configurations of the invention arise from the description, and from the attached drawings.

It is understood that the above-mentioned features, and those described hereinafter, are not only applicable in the respective combination indicated, but also in other combinations or in isolation, without departing from the scope of the present invention.

The invention is schematically represented in the drawings, on the basis of exemplary embodiments, and is described hereinafter with reference to the drawings.

### DESCRIPTION OF FIGURES

FIG. 1 shows a schematic representation of a section of an arrangement for the wiring of components in a section of a stator arrangement according to a preferred form of embodiment.

FIG. 2 shows a schematic representation of an elevator installation according to a preferred form of embodiment of the invention.

In the following figures, identical elements are identified by the same reference numbers, unless expressly indicated otherwise. Elements in the figures which have been described with reference to preceding figures, will not be described again in the interests of brevity, even if these descriptions also relate to elements represented in the further figures, unless indicated otherwise.

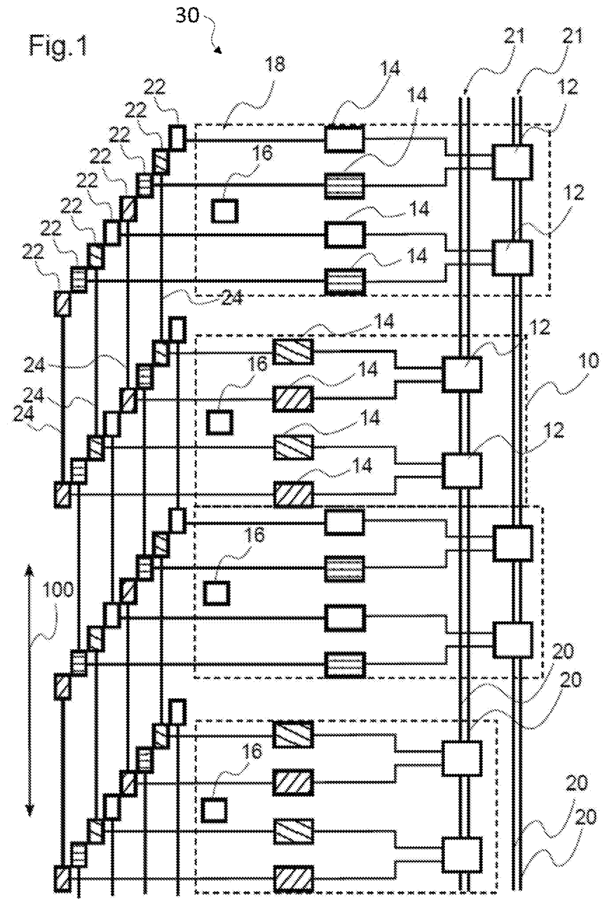

FIG. 1 shows a schematic representation of a section of an arrangement for the electrical cabling of electrical components in a section of a stator arrangement 18 according to a first preferred form of embodiment. In the interests of clarity, not all components are identified by reference symbols, but only a number of components of the same type, for exemplary purposes. For example, of the thirty-two stator coils 22 represented, only the eight upper coils are marked. The same applies correspondingly to the other components. Identical graphic symbols represent identical or equivalent electrical components. In the section represented, the stator arrangement 18 comprises a plurality of supply segments 10, which are arranged one above another along the longitudinal direction 100. Each of the supply segments 10 comprises two connection elements 12 here and four converters 14 wherein, via each of the two connection elements 12, two converters 14 respectively are connected or bonded. Via the connection elements 12, each of the supply segments 10 is bonded to a supply terminal 21 which, in turn, comprises two supply lines 20. Via the supply terminal 21, the supply segments 10 can be supplied with electrical energy and, optionally, with signal data. Each of the connection elements 12 is respectively supplied here with electrical energy by two supply lines 20 in a redundant arrangement such that, in the event of a malfunction and/or a failure of one of the supply lines 20, the connection elements 12 which are connected thereto can nevertheless be supplied with electrical energy via the other respective supply line 20 of the supply terminal 21.

Each of the four converters 14 per supply segment 10 is respectively connected to two stator coils 22 and, in turn, supplies these stator coils 22 with electrical energy. The four converters 14 represented at the upper end are also respectively connected to two stator coils 22 although, in the section of the stator arrangement 18 represented, only one respective stator coil 22 appears to be connected to the respective converters 14. The further overlying stator coils 22 are simply arranged outside the represented section of the stator arrangement 18. The two stator coils 22, which are connected to the same converter 14, are thus not adjacently or contiguously arranged, but are configured in a spaced arrangement such that, according to a preferred form of the embodiment represented, seven further stator coils 22 are arranged between the respective stator coils 22, wherein the intervening stator coils 22 are supplied with electrical energy by other converters 14. The two stator coils 22, which are connected to the same converter 14, are interconnected by means of a line 24. This type of arrangement of stator coils 22 or the cabling of stator coils 22 with converters 14 provides the advantage in that, in the event of a malfunction in and/or a failure of one converter 14, two adjoining stator coils 22 are not lost, but the lost stator coils 22 adjoin other stator coils 22 which are not affected by the failure of the converter 14. In the interests of clarity, the converter 14 and the two stator coils 22 which are connected to said converter 14 are represented by the same cross-hatching.

Moreover, also stator coils 22 which are supplied with electrical energy via the same connection element 12 and which are optionally supplied with electrical energy via the same supply segment 10, or the converters 14 of which stator coils are supplied via the same connection element 12, are not arranged directly next to one another but are arranged in a way that, in each case, other stator coils 22 are situated between the stator coils 22, which are supplied via another connection element 12, and optionally via another supply segment 10. This provides the advantage in that, in the event of a failure of a connection element 12 and/or of an entire supply segment 10, a plurality of directly adjoining stator coils 22 are not affected by the failure, but other stator coils 22, which are not affected by the failure, are arranged between the stator coils 22 which are affected by the failure. According to the form of embodiment represented, the connection elements 12 are configured as tap-off boxes.

In the absence of the failure and/or of the functional impairment of a plurality of directly adjoining stator coils 22, according to the preferred form of embodiment, the function and/or operation of the stator 18 can be maintained, such that a rotor can continue to be moved relative to the stator 18 and/or an uncontrolled movement of the rotor relative to the stator, specifically a falling, can be prevented notwithstanding the failure of a number of stator coils 22.

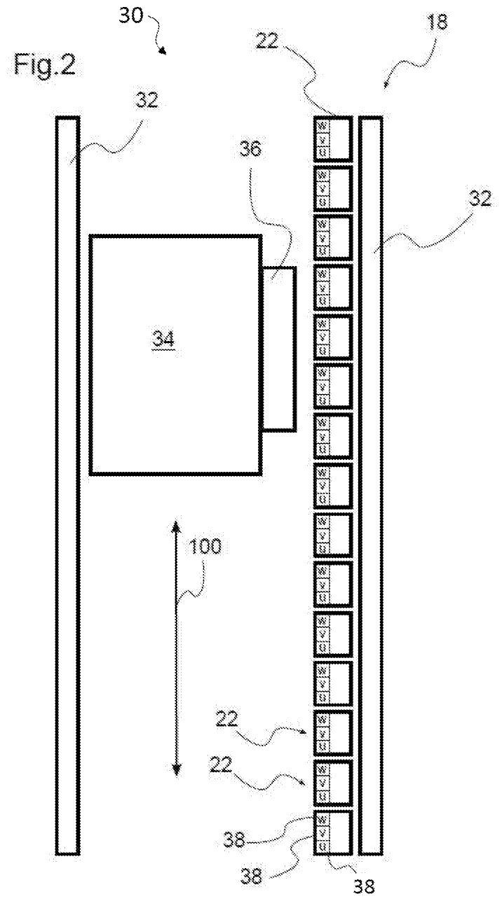

The horizontally offset representation of the stator coils 22 is specifically intended here to improve clarity, by way of the restriction of number of intersection points in the electric lines represented. A geometrical arrangement of stator coils 22 does not necessarily need to be offset. Preferably, the stator coils 22 are arranged in a row, such that said stator coils constitute a track for a rotor, which is to be moved along the stator 18. This is represented in FIG. 2.

FIG. 2 shows a schematic representation of an elevator installation 30 having a stator arrangement 18 and a rotor 34 which, by means of the stator arrangement 18, is moveable along the stator arrangement 18 along the longitudinal direction 100. The rotor 34 can be configured, for example, as a car.

The stator arrangement 18 comprises here a plurality of stator coils 22 arranged in a row along the longitudinal direction 100, each of which comprises a plurality of terminals 38 for the supply thereof with electrical energy. Each of the stator coils is supplied with electrical energy via a supply segment 10, or via a connection element 12, or via a converter 14 (see FIG. 1).

According to the form of embodiment represented in FIG. 2, the elevator installation 30 comprises a plurality of carrier elements 32, to which the stator coils 22 are preferably fastened. For example, the carrier elements 32 can comprise a rail system, which is fastened in an elevator shaft or to a wall.

The rotor 34 comprises at least one magnetic element 36, by means of which the rotor can interact with the magnetic fields generated by the stator coils 22, such that the stator 18, by means of these magnetic fields, can direct and/or control the position of the rotor, and specifically can move the latter along the longitudinal direction 100. For example, the at least one magnetic element 36 can comprise one or more permanent magnets.

The dimensions of the rotor 34 or of the least one magnetic element 36, and of the stator coils 22, according to the preferred form of embodiment, are such that the rotor 34, at any potential position along the longitudinal direction 100 of the stator, interacts with at least two stator coils 22. The elevator installation (30) is moreover preferably configured such that the position of the rotor 34 can be stabilized and/or controlled, and the latter can preferably be moved along the longitudinal direction 100 in a controlled manner, even by only one stator coil 22 such that the rotor 34, even in positions in which the latter is at least partially arranged adjacently to a failed or a malfunctioning stator coil 22, can be controlled and/or moved. This means that the interaction of the rotor 34 with only one stator coil 22 is sufficient to control and/or move the rotor, such that the operation of the elevator installation 30 can be maintained, even in the event of a failure of one stator coil 22 or of a plurality of non-adjoining stator coils 22.

1.-13. (canceled)

14. A stator arrangement for an electromagnetic linear drive, the stator arrangement comprising:
stator coils disposed along a longitudinal direction of a stator; and
converters, wherein each of the converters is configured to supply a first stator coil and a second stator coil of the stator coils with electrical energy, wherein a third stator coil of the stator coils is disposed between the first and second stator coils, wherein the third stator coil is supplied with electrical energy by a converter that is different than a converter that supplies the first and second stator coils with electrical energy.

15. The stator arrangement of claim 14 comprising connection elements, wherein each of the connection elements is configured to supply a first converter and a second converter with electrical energy, wherein each of the first and second converters is configured to supply at least two of the stator coils with electrical energy, wherein those stator coils that are supplied with electrical energy via the same connection element form a first group of stator coils, wherein another stator coil that is disposed between two stator coils of the first group of stator coils is supplied via another connection element of the connection elements.

16. The stator arrangement of claim 15 comprising supply segments, wherein each of the supply segments comprises at least two supply components from the converters and the connection elements, wherein those stator coils that are supplied with electrical energy via the same supply segment form a second group of stator coils, wherein another stator coil that is disposed between two stator coils of the second group of stator coils is supplied via another supply segment of the supply segments.

17. The stator arrangement of claim 16 wherein the supply segments are individually mountable to the stator and/or individually removable from the stator.

18. The stator arrangement of claim 16 wherein each of the supply segments comprises a sensor element that is configured to deliver a sensor signal in response to a presence of a rotor at a given position on the supply segment, wherein the rotor is movable relative to the stator.

19. The stator arrangement of claim 16 wherein each of the supply segments comprises at least one of the converters.

20. The stator arrangement of claim 19 wherein at least one of the converters of one of the supply segments, in a transverse direction that is perpendicular to the longitudinal direction of the stator, is disposed at least partially away from a center of the one of the supply segments.

21. The stator arrangement of claim 15 comprising supply terminals, wherein each of the supply terminals is configured to supply a first connection element and a second connection element of the connection elements with electrical energy, wherein those stator coils that are supplied with electrical energy via the same supply terminal of the supply terminals form a second group of stator coils, wherein a further stator coil is disposed between two stator coils of the second group of stator coils, wherein the further stator coil is supplied via another supply terminal of the supply terminals.

22. The stator arrangement of claim 21 wherein each of the supply terminals comprises at least two supply lines.

23. The stator arrangement of claim 22 wherein the at least two supply lines comprise a redundant arrangement for supply of electrical energy to the supply terminals.

24. The stator arrangement of claim 14 wherein the stator coils are disposed along the stator such that the stator coils form a track for a rotor that is movable relative to the stator.

25. The stator arrangement of claim 14 at least partially oriented in a vertical direction and/or at least partially oriented in a horizontal direction, wherein the longitudinal direction is parallel to an orientation of the stator.

26. An elevator installation comprising the stator arrangement of claim 14.
